(19) United States
(12) Patent Application Publication
(10) Pub. No.: US 2013/0254906 A1
(43) Pub. Date: Sep. 26, 2013

(54) Hardware and Software Association and Authentication

(71) Applicants: Richard E. Kessler, Northborough, MA (US); Muhammad Raghib Hussain, Saratoga, CA (US); Ethan Frederick Robbins, North Grafton, MA (US)

(72) Inventors: Richard E. Kessler, Northborough, MA (US); Muhammad Raghib Hussain, Saratoga, CA (US); Ethan Frederick Robbins, North Grafton, MA (US)

(73) Assignee: Cavium, Inc., San Jose, CA (US)

(21) Appl. No.: 13/427,148

(22) Filed: Mar. 22, 2012

(51) Int. Cl. G06F 21/00

(52) U.S. Cl. 726/34

(57) ABSTRACT

Authentication and association of hardware and software is accomplished by loading a secure code from an external memory at startup time and authenticating the program code using an authentication key. Access to full hardware and software functionality may be obtained upon authentication of the secure code. However, if the authentication of the secure code fails, an unsecure code that provides limited functionality to hardware and software resources is executed.

### BACKGROUND

Device cloning and unauthorized production of products may result in loss of revenue and brand equity for companies. Such cloning activity leverages research and development of original equipment manufacturers (OEMs) to offer similar and competing products at a lower cost. Naturally, this results in significant loss of profit and brand equity to the OEM. For example, non-branded systems that rely on stolen hardware designs and clone systems, which are typically built at lower quality, may be used to compete with OEMs at reduced costs. The manufacturers of such cloned systems also often copy the software from the original product and offer a complete system (e.g., non-branded servers and routers) at very low cost.

In addition to profit loss, unauthorized production of products may cause an interruption in the business model of an OEM. For example, hackers can change the functionality of existing systems to behave and perform non-intended functions that disrupt the business model of OEMs. Further, contractors may overbuild equipment beyond the OEM's order and sell the unauthorized equipment with the same brand but at lower price and no revenue to the OEM.

The Trusted Computing Group (TCG) is an industry group including component vendors, software developers, systems vendors and network and infrastructure companies that develops and supports open industry specifications for trusted computing across multiple platform types. TCG has defined a Trusted Platform Module (TPM) specification for microcontrollers that store keys, passwords and digital certificates. Security processes, such as digital signature and key exchange, are protected through the secure TCG subsystem. Access to data and secrets in a platform could be denied if the boot sequence is not as expected. Critical applications and capabilities such as secure email, secure web access and local protection of data are thereby made much more secure. The TPM is not capable of controlling the software that is executed. The TCG subsystem can only act as a ‘slave’ to higher level services and applications by storing and reporting pre-runtime configuration information. Other applications determine what is done with this information. At no time can the TCG building blocks ‘control’ the system or report the status of applications that are running.

### SUMMARY

A method and corresponding apparatus in an example embodiment of the present invention authenticates and associates a secure code with an equipment by loading the secure code from an external memory at startup time and authenticating the secure code using an authentication key associated with the equipment and in an event authentication of the secure code fails, executing an unsecure code.

In certain embodiments, the external memory may be at least one of an unsecure memory, a reprogrammable flash memory, or a read-only memory (ROM).

In some embodiments, the secure code may be stored in an internal memory of the equipment. The secure code may be stored using instructions from a ROM. The secure code may be executed in an event the secure code is authenticated. In some embodiments, the secure code may be executed from the internal memory in an event the secure code is authenticated. In some embodiments, in an event the secure code is authenticated, the procedures triggered by execution of the secure code may further be authenticated.

In some embodiments, the secure code may be copied into a secure internal writable memory using instructions from a ROM. The secure internal writable memory may be a partition of a cache memory, and may be arranged to execute the secure code. In some embodiments, the secure code may be unencrypted.

In certain embodiments, a cache memory may be partitioned to include the internal memory. The internal memory may reside at an address within the cache memory and have a dynamically variable size.

In some embodiments, secure keys associated with the equipment may be loaded from the external memory using the secure code. The secure keys may include at least one of a device authentication key, a redundant device authentication key, a chip encryption key, an image authentication key, a memory protection key, and a secure storage key. The secure keys may be unencrypted or encrypted. The secure keys may be authenticated using the secure code. In certain embodiments, the secure code may be used to determine if updates to the secure keys are available. In some embodiments, the secure keys may be updated using an update code. In some embodiments, some secure keys may be compared to a secret key using the secure code and in an event the comparison fails, issuing an error indication.

In certain embodiments, a secure earliest boot code authenticator is a function of the authentication key and the secure code, the authentication key being a function of a Master Authentication Key (MAK) associated with the equipment. The authentication key may be encrypted. In some embodiments, the secure earliest boot code may be executed from the secure internal writable memory. In certain embodiments, the authentication key may be authenticated and in an event the authentication fails, the unsecure code may be executed with an appropriate error indication.

In certain embodiments, an error signal may be generated in an event authentication of the secure code fails.

In some embodiments, the unsecure code may be executed from at least one of the internal memory and the external memory. The unsecure code may include limited functionality. In some embodiments, having limited functionality may include having limited access to structures of the equipment. In certain embodiments, having limited functionality may include having limited access to software stored on the equipment. Some embodiments may provide the limited functionality for a predetermined period of time. The unsecure code may be unencrypted and alterable.

In some embodiments, the authentication key may be determined as a function of a Master Authentication Key (MAK) associated with the equipment. In certain embodiments, the authentication key may be an Advanced Encryption Standard (AES) Key. In some embodiments, the secure code includes an authenticator. The authenticator may be a function of the authentication key.

In some embodiments, the equipment may be at least one of a network processor, a general purpose processor system-on-chip, and a mother board.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a block diagram of secure software and hardware association (SSHA) circuitry according to embodiments of the present invention.

FIG. 2 illustrates a high-level block diagram of Secure Keys.

FIG. 3 is a flow diagram of procedures that may be performed with certain embodiments.

### DETAILED DESCRIPTION

A description of example embodiments of the invention follows.

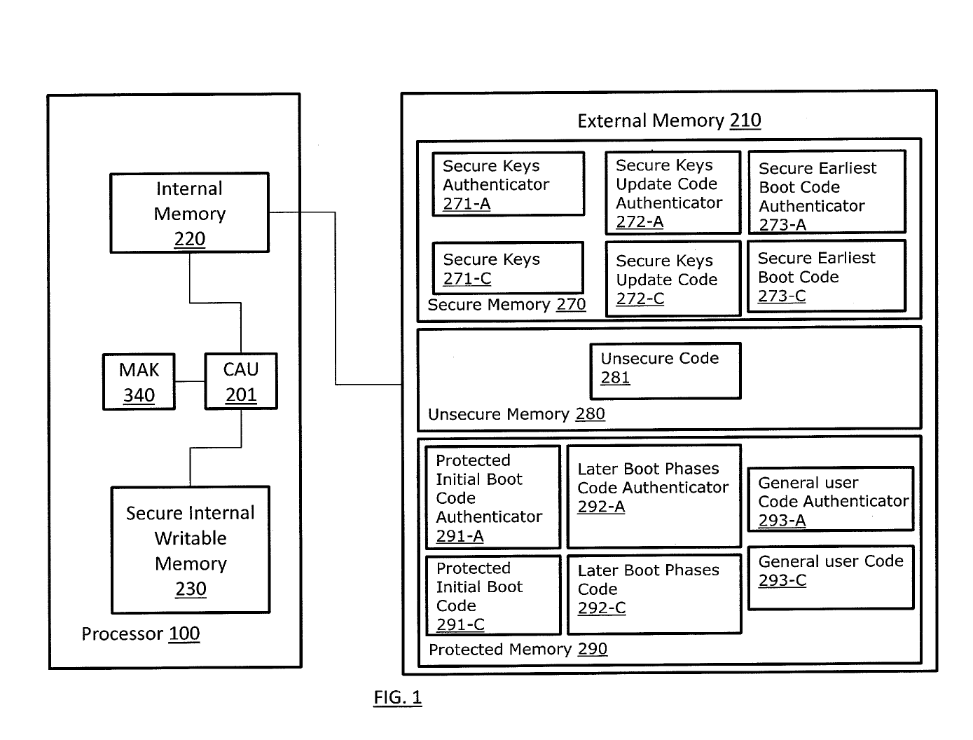

FIG. 1 illustrates a block diagram of an example embodiment of secure software and hardware association (SSHA) circuitry 100 that may be used with embodiments of the present invention. The SSHA supports two capabilities:
Original equipment manufacturer (OEM) hardware will only run OEM software; and
OEM software will only run on OEM hardware.

As illustrated, the SSHA circuitry 100 includes an external memory 210 that is coupled to a processor 100 having an internal memory 220. The external memory 210 may be an unsecure memory, a reprogrammable flash memory, or a read-only memory (ROM). The external memory 210 may include a secure memory 270, unsecure memory 280, or protected memory 290.

The internal memory 220 may be an on-chip instruction memory, such as a read-only memory (ROM). The internal memory 220 often holds the functions needed for implementation of secure software and hardware association functions. The information held in the internal memory 220 may be encrypted or unencrypted. However, regardless of encryption, since the internal memory 220 resides on-chip, it is completely secure and protected from chip-external adversaries.

At startup time, instructions stored in the internal memory 220 load a secure earliest boot code 273-C from the external memory 210. The secure earliest boot code 273-C may be boot code or application software. The secure earliest boot code 273-C is authenticated, by a secure earliest boot code authenticator 273-A, using an authentication key (not shown). The secure earliest boot code authenticator 237-A uses a function of the secure earliest boot code 273-C and a Master AES Key (MAK) 340. For example, the authentication key may be an AES-CBC MAC (Message Authentication Code) that uses the MAK 340 as the AES key. The MAK 340 is unique to each processor 100 and, as such, the secure earliest boot authenticator 273-A is also unique to each processor 100.

Secure memory 270 is the most secure region in the external memory 210 and stores the earliest boot codes in addition to keys for later boot stages and codes to update these keys. The MAK 340 is generally used to protect the secure memory 270 and protect execution of the code stored in the secured memory 270. In one embodiment, the MAK is not used by later boot stages. The protected memory 290 stores later boot stages and user code. The protected memory 290 is typically protected by secure keys. The unsecured memory 280 stores code that is, in many embodiments, not protected by any keys.

In certain embodiments, the secure earliest boot code 273-C may be authenticated by the internal memory 220 using a code authentication unit (CAU) 201 that retrieves the authenticator 273-A from the external secure memory 270 and uses the MAK 340 to authenticate the secure earliest boot code 273-C for the processor 100. The CAU 201 may be programmable logic.

Once authenticated, the secure earliest boot code 273-C may be stored in the internal memory 220 of the equipment. However, if the authentication of the secure earliest boot code 273-C fails, the internal memory instructions execute an unsecure code 281, from the unsecure memory 280 portion of the external memory 210, with an appropriate error indication. The unsecure code 281 usually executes with limited privileges.

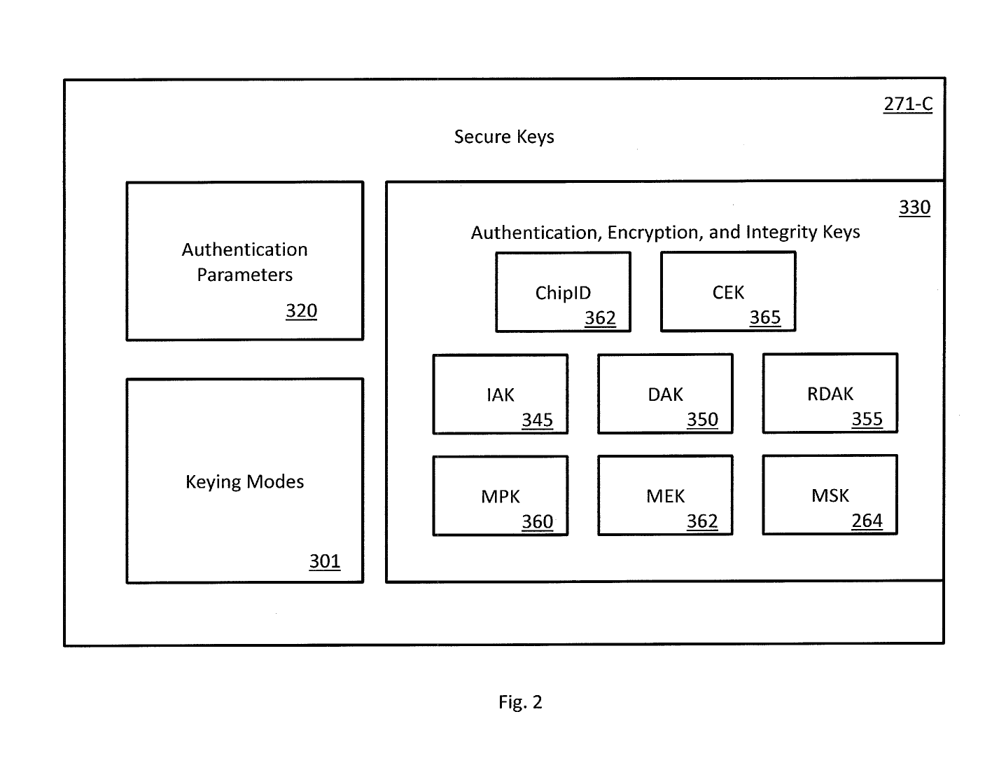

The secure memory 270 further includes a Secure Keys authenticator 271-A that authenticates the information and keys used for authentication, encryption, and integrity (hereinafter generally referenced to as Secure Keys 271-C). The Secure Keys authenticator 271-A may also store authentication parameters 320 (shown later with reference to FIG. 2) used to perform authentication operations.

The secure memory 270 may further include a secure keys update code authenticator 272-A. The secure keys update code authenticator 272-A may be used to authenticate information (hereinafter generally referenced to as secure keys update code 272-C) for updating the secure keys 271-C. The secure keys update code 272-C can also update secure keys update code 272-C and/or the secure earliest boot code 273-C. The secure keys update code 272-C may further determine when and how to perform updates to the secure keys by using information obtained from the external memory 210. In some embodiments, the update code authenticator may be authenticated using the MAK 340 (described later with reference to FIG. 2) or by other authentication keys.

The secure keys update code 272-C typically runs with full privileges and may have access to the MAK. As such, the secure keys update code 272-C must be authenticated and may also be encrypted. Once authenticated, the secure keys update code 272-C may be granted its full privileges. However, if not authenticated (i.e., if there are errors and/or authentication failures), the unsecure code 281 may be executed along, from the unsecure memory 281, with an appropriate error indication. In such instances, the unsecure code 281 may run with limited privileges and/or for a limited period of time.

The protected memory 290 portion of the external memory 210 may include a protected initial boot (PIB) code authenticator 291-A that is used to authenticate (PIB) code 291-C. The secure earliest boot code 273-C and/or the secure keys update code 272-C may be used to authenticate the Secure Keys 271-C. The (PIB) code 291-C is normally executed after the secure code is successfully authenticated.

In some embodiments, the (PIB) code 291-C initially runs out of a secure internal writable memory 230 section of the processor 100. The (PIB) code 291-C has limited functionality and requires subsequent boot phases to startup the processor 100. The information regarding the subsequent boot phases (later boot phases code 292-C) may be stored in the protected memory 290 and authenticated using a later boot phases code authenticator 292-A. Further, in certain embodiments, subsequent boot phases may be authenticated through a dynamic random access memory (DRAM, not shown) portion of the processor 100.

In certain embodiments, a ROMEN boot field, stored within the processor 100, is used at startup to determine whether the processor 100 should execute an SSHA boot. In an embodiment, the ROMEN boot field is a bit or other Boolean representation. The ROMEN boot field is set to 1, or “is set,” when performing secure software and hardware association, which accesses the internal memory 220. In other words, SSHA booting of the processor is enabled when the ROMEN boot field is set to 1. In all other circumstances, the ROMEN boot field is set to zero, or is “not set.” When the ROMEN boot field is set to zero, the processor 100 boots by accessing external memory 210. The ROMEN boot field is set by hardware before boot to enable access to internal memory 220. When the ROMEN boot field is set to 1, the internal memory 220 runs before the processor 100 is fully functional and initiates the secure software and hardware association procedures described herein. Specifically, the internal memory 220 is enabled at a physical address within the standard boot location of the processor 100 and when the ROMEN boot field is set (i.e., set to 1), the processor 100 executes instructions included in the internal memory 220.

In some embodiments, the protected memory may include general user code 293-C that may be used to perform further authentication and hardware-software association. In one embodiment, general user code 293-C includes more than one piece of code. A general user code authenticator 293-A may be used to authenticate the general user code 293-C. In one embodiment, the general user code authenticator 293-A includes more than one authenticator. However, in many embodiments, the general user code 293-C is used to perform the user's task.

The instructions stored in the internal memory 220 are, typically, the first instructions executed at startup time. The primary function of these internal memory instructions is to store, load, and/or execute the secure earliest boot code 273-C once authenticated. However, prior to loading and executing the authenticated secure earliest boot code 273-C, the internal memory instructions create an on-chip secure internal writable memory 230 that holds the secure earliest boot code 273-C. The on-chip secure internal writable memory 230 may be created by partitioning a cache memory (not shown) such that the on-chip secure internal writable memory 230 resides at an address within the cache memory and has a dynamically variable size. In some embodiments, the on-chip secure internal writable memory 230 may reside in a Level-2 cache memory (not shown).

The on-chip secure internal writable memory 230 may be used to execute early startup functions, including holding and executing the secure earliest boot code 273-C, that occur prior to initialization of the processor. The on-chip secure internal writable memory 230 resides on-chip and, as such, is secure and protected from external adversaries. In addition to holding and executing the secure earliest boot code 273-C, the on-chip secure internal writable memory 230 may be used to load Secure Keys 271-C from the external memory 210 using the secure earliest boot code 273-C.

In some embodiments, the on-chip secure internal writable memory 230 may be used to store the authentication key. As noted previously, since the on-chip secure internal writable memory 230 is on-chip, it is protected from external adversaries. Accordingly, the on-chip secure internal writable memory 230 may be used to safely store the authentication key 245. The authentication key 245 may be stored in encrypted or unencrypted formats on the on-chip secure internal writable memory 230.

FIG. 2 illustrates a high-level block diagram of the Secure Keys 271-C. The Secure Keys 271-C store the information and keys used for authentication, encryption, and integrity 330. The Secure Keys 271-C may also store authentication parameters 320 used to perform authentication operations.

Various keying modes 301 or options for storing the Secure Keys 271-C may be used. For example, a direct keying mode in which the Secure Keys 271-C are stored inside an SSHA-enabled device (not shown, e.g., silicon device) may be used. In a preferred embodiment, an indirect keying mode may be used. The indirect keying mode may store the Secure Keys 271-C as part of a binary image. In certain embodiments, the Secure Keys 271-C may be stored external to the SSHA-enabled device (e.g., flash device attached to the SSHA-enabled device).

In some embodiments, the Secure Keys 271-C may be stored in the secure internal writable memory 230. Given that the secure internal writable memory 230 is secure, the Secure Keys 271-C and its keying modes 301 may be stored in either unencrypted or encrypted formats. In certain embodiments, the Secure Keys 271-C may be stored in the secure memory 270 portion of the external memory 210.

The contents of the Secure Keys 271-C may be encrypted by a unique Advanced Encryption Standard (AES) key for each SSHA-enabled device. For example a unique AES 256-bit key, such as the MAK 340, may be used to encrypt the Secure Keys 271-C. Therefore, the MAK 340 is generally not stored within the Secure Keys 271-C.

In certain embodiments, the MAK 340 (FIG. 1) is generated by the hardware. The MAK 340 may be a function of a secret value and a chip ID 362. The chip ID 362 may be readable but the secret value may not be read by software.

In certain embodiments, a MAK 340 (FIG. 1) keying mode may be selected and installed in an SSHA-enabled device during manufacturing of the SSHA-enabled device. The MAK 340 (FIG. 1) is not disclosed and is not accessible by anyone. In some embodiments, the MAK 340 (FIG. 1) may be designed so that it cannot be read out or changed. Further, the MAK 340 (FIG. 1) may remain the same for any given device having cryptographic association mechanisms according to embodiments of the present invention and may serve as the basis for establishing a relationship between the Secure Keys 271-C and the device.

In some embodiments, other secure keys authentication keying modes may be used. Examples of such secure keys authentication keying modes include: the device authentication key 350 (DAK), the redundant device authentication key 355 (RDAK), the chip encryption key 365 (CEK), the image authentication keys 345 (IAK), the memory protection key 360 (MPK), and the secure storage key (not shown).

The DAK 350 is a public key used to establish the ownership of a device. The DAK 350 may be used to authenticate Secure Keys 271-C write and/or update messages. By authenticating the write/update messages, the DAK 350 controls the keys stored in the Secure Keys 271-C. In certain embodiments, a corresponding private key (not shown) may be associated with the DAK 350. The device owner (i.e., OEM) owns the private key corresponding to DAK 350.

In some embodiments, a redundant device authentication key (RDAK) 355 may be used. The RDAK 355 is a redundant public key used to establish the ownership of a device. The RDAK 355 is used to authenticate Secure Keys 271-C write/update messages. By authenticating Secure Keys 271-C write/update messages, the RDAK 355 authenticates and controls the keys stored in the Secure Keys 271-C. In certain embodiments, a corresponding private key (not shown) may be associated with the RDAK 355. The device owner (i.e., OEM) owns the private key corresponding to RDAK 355.

In certain embodiments, the RDAK 355 may be updated by DAK 350 or RDAK 355 private key owner using a Secure Keys 271-C update mechanism. The RDAK 355 implementation is optional and is not required for the complete functionality of the cryptographic association mechanisms described herein.

The CEK 365 may be any symmetric encryption key. The CEK 365 is associated with any given device having cryptographic association mechanisms according to embodiments of the present invention. The CEK 365 is part of the Secure Keys 271-C and is used to protect the binary image, which is the vendor software. The CEK 365 may be unique on a per device basis or it can be same for a group of devices or all devices belonging to an OEM.

Further, the CEK 365 may be changed over a secure connection by receiving a request signed by an associated asymmetric OEM private key that provides a new symmetric CEK 365. Moreover, the CEK 365 may be updated by the owner of the DAK 350 or RDAK 355 private keys using a Secure Keys 271-C update mechanism. The CEK may be read in a DAK 350 or RDAK 355 public key encrypted container using a Secure Keys 271-C access mechanism.

The IAK 345 may include one or more public keys that are used to authenticate binary images that can run on corresponding SSHA-enabled devices.

In some embodiments, the IAK 345 may be stored in an indexed table used to refer to the keys during program code image authentication process.

In certain embodiments, the IAK 345 may be updated by the owner of DAK 350 or RDAK 355 private keys using Secure Keys 271-C update mechanism. In some embodiments, the IAK 345 may be read in a DAK 350 or RDAK 355 public key encrypted container using a Secure Keys 271-C access mechanism.

In some embodiments, the MPK 360, which is an Advanced Encryption Standard (AES) base key, may be used to protect contents of the main memory and is part of Secure Keys 271-C. In certain embodiments, the DRAM (not shown) of the processor 100 may be optionally divided into fully secure and protected regions and a DRAM controller of an SSHA-enabled processor may be arranged to include built-in logic for encryption/decryption and scrambling/descrambling. Data stored in a fully secured region may be encrypted or decrypted using a memory encryption key (MEK) 362. In certain embodiments, the data stored to protected regions of the memory may be scrambled or descrambled using a memory scrambling key (MSK) 364. The MSK 364 and MEK 362 may be derived from MPK 360.

In certain embodiments, the secure code may also be used to authenticate the secure keys. The secure code may further be used to determine if updates to the secure keys are available. In some embodiments, an update code may be used to update the secure keys. The update code may determine when and how to perform updates to the secure keys by using information obtained from the external memory 210 (shown FIG. 1). In certain embodiments, there may be an authenticator associated with the update code. This update code authenticator may be authenticated by the MAK 340 or by other authentication keys.

The update code typically runs with full privileges and may have access to the master authentication key. As such, the update code must be authenticated and may also be encrypted. In some embodiments, to ensure secure execution, the update code runs out of the secure internal writable memory 230 (shown FIG. 1). Once authenticated, the update code may be granted its full privileges. However, if not authenticated (i.e., if there are errors and/or authentication failures), the secure code instead executes the unsecure code with an appropriate error indication. As noted previously, the unsecure code may run with limited privileges and/or for a limited period of time.

In some embodiments, all program code executed in the processor 100 (FIG. 1) is validated and authenticated prior to execution to prevent unauthorized program code from gaining access to the system. In some embodiments, some customer code is encrypted to prevent a possible adversary from copying the code.

Further, in some embodiments, the updates to the Secure Keys 271-C may be authenticated using an authentication key. In some embodiments, the authentication key may include the authentication key (described with reference to FIG. 2). The authentication key may be encrypted or unencrypted. In certain embodiments, the authentication key may be executed from the secure internal writable memory 230 (FIG. 1) to ensure its security.

Embodiments of the present invention prevent OEM software from running on anything other than OEM hardware. However, given access to certain keys within the Secure Keys 271-C and the authentication key, it may be possible for an adversary to run old versions of a secure code or the Secure Keys 271-C on the processor 100 (FIG. 1). In order to prevent from doing so, certain embodiments of the present invention limit access to the processor only through the external code and only allow the final OEM to access the secure code and Secure Keys 271-C.

In some embodiments, in order to prevent an adversary from using older versions of the Secure Keys 271-C and the secure earliest boot code 273-C, a secret key (not shown) may be used. The secure earliest boot code 273-C may compare the secret key to a Secure Keys 271-C field and consider it a failure if the fields do not match. To ensure that only the OEM has access to the Secure Keys 271-C, the secret key value is kept from all processor 100 (FIG. 1) users except for the OEM.

As noted previously, if the authentication of the secure earliest boot code 273-C fails, the secure internal writable memory 230 instructions execute an unsecure code 281 with an appropriate error indication. The unsecure code 281 may also be executed if authentication of updates to secure keys fails. The unsecure code 281 may also be executed in other circumstances. For example, the unsecure code 281 may be used to offer limited access to the processor 100 resources. For example, the unsecure code may be used to offer limited usage/testing to a user that does not have access to the secure earliest boot code 273-C or Secure Keys 271-C.

In certain embodiments, if the authentication of the secure earliest boot code 273-C fails, the unsecure code 281 may assert a general purpose input/output (GPIO) flag and stall or jump to a specific location after disabling the system to a limited debug only mode.

The unsecure code 281 typically runs with limited privileges and has limited access to software and system structures. The unsecure code 281 may be unencrypted and unauthenticated. In some embodiments, the unsecure code 281 may be freely modifiable by adversaries. Although, the unsecure code 281 may initially runs out of the secure internal writable memory 230 portion of the external memory 210, in certain embodiments, the unsecure code 281 may run out of the unsecure memory 280 (FIG. 1). Further, if needed for advanced functions, in some embodiments, the unsecure code 281 may perform further chip initialization.

Embodiments of the present invention provide hardware, software, and system structure solutions that restrict usage of the MAK 340, and reduce access to secure keys, and protect the system from adversaries. Restriction of access to the MAK 340 is critical because once an adversary gains access to the MAK 340, it can potentially decode the Secure Keys 271-C and gain access to all code.

In order to restrict access to the MAK, embodiments of the present invention employ a function that can disable access to the MAK (herein after referenced as “DIS_MAK”). If the DIS_MAK field is clear, the MAK can be accessed. However, when the DIS_MAK filed is set, the hardware prevents any access to the MAK 340. The hardware may also prevent the DIS_MAK field from being cleared.

As noted above, authentication of internal memory 220 (FIG. 2), secure code, and update code occurs at early startup, before the processor 100 (FIG. 1) is fully functional. Outside of early start up, since the possibility that adversarial software is being run exists, access to the MAK is disabled by setting the DIS_MAK field. Further, when performing other processing steps, such as execution of unsecure code or customer-specific code, the hardware does not allow the MAK 340 to be used or accessed and the DIS_MAK field remains set. In addition, certain embodiments allow the DIS_MAK field to remain set during authentication of the Secure Keys 271-C and the secure keys update code 272-C.

Certain embodiments may include additional functionality for limiting access to the processor 100 (FIG. 1). For example, certain embodiments may employ a function (hereinafter referenced as “CHIPKILL”) to limit processor 100 (FIG. 1) functionality available to the external code. It is important to limit external code access, since external code execution may indicate unauthorized use of the processor 100 (FIG. 1) by an adversary. In some embodiments, the CHIPKILL functionality may include restricting the number of processor cores of the processor 100 that are being used. In certain embodiments, the CHIPKILL functionality may prevent access to the processor 100 (FIG. 1) after a predetermined period of time. In some embodiments, the CHIPKILL functionality can be extended to disable certain input/output characteristics of the processor 100 (FIG. 1). Further, certain embodiments may prevent the CHIPKILL functionality from being disabled.

In certain embodiments when the CHIPKILL field is set, all processor cores other than one core are optionally held in reset. On the transition of the CHIPKILL field from 0 to 1, the hardware initiates a CHIPKILL timer. When the timer expires, if the CHIPKILL field is still set, the hardware internally forces an instruction to assert that holds the chip in reset until the next chip reset.

The CHIPKILL timer may be set to any predetermined period of time. For example, in one embodiment, the CHIPKILL timer may be approximately 20 seconds by default. The CHIPKILL timer may only be stopped by a chip reset. In some embodiments, the CHIPKILL timer interval is selected by a CHIPKILL[TIMER] field that controls the amount of the time the CHIPKILL field remains set and may be as large as a day or more.

In certain embodiments, the DRAM contents may be scrambled. This is to prevent a chip adversary from accessing the protected code and data by simply monitoring reads/writes occurring in the DRAM of the processor 100.

Most authentication and verification functions of the example embodiment may be stored on and executed from the external memory 210, where storage is more cost effective. As such, the internal memory 220 need not to be large and may have limited functionality.

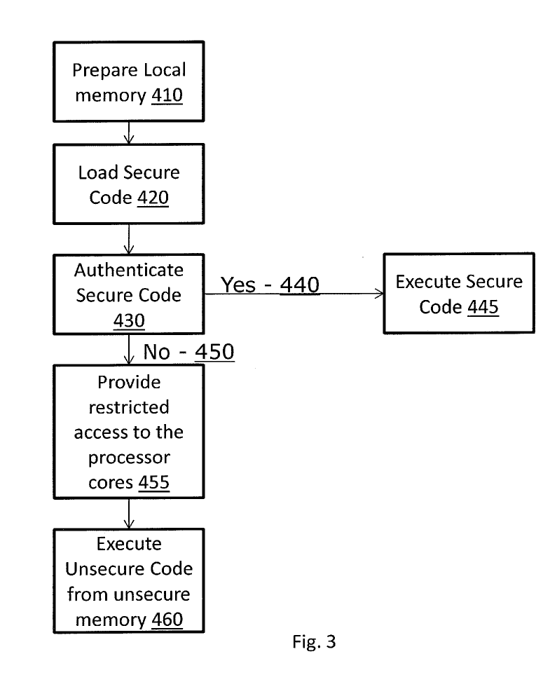

FIG. 3 is a flow diagram 400 of the procedures that may be performed with certain embodiments. At startup time, instructions from an internal memory are used to prepare a secure internal writable memory 410. The secure internal writable memory resides at a physical address and has a size smaller than that of the cache memory of the processor 100 (FIG. 1). A secure code is loaded from an external memory into the secure internal writable memory 420 and authenticated 430. If the secure code authenticates 440, the secure code is executed 445. If the secure code does not authenticate 450, in embodiments that include the functionality for limiting access to the processor 100 (FIG. 1), certain functionalities may be used to restrict access 455 to the processor. Then, an unsecure code is executed from an unsecure memory 460. The unsecure code may be executed from an unsecure memory, a reprogrammable flash memory, or a read-only memory (ROM).

While this invention has been particularly shown and described with references to example embodiments thereof, it will be understood by those skilled in the art that various changes in form and details may be made therein without departing from the scope of the invention encompassed by the appended claims.

What is claimed is:

1. A method for authenticating and associating a secure code with an equipment, the method comprising:
loading the secure code from an external memory at startup time; and
authenticating the secure code using an authentication key associated with the equipment and in an event authentication of the secure code fails, executing an unsecure code.

2. The method of claim 1 wherein the external memory is at least one of an unsecure memory, a reprogrammable flash memory, or a read-only memory (ROM).

3. The method of claim 1 further comprising storing the secure code in an internal memory of the equipment.

4. The method of claim 3 further including partitioning a cache memory to include the internal memory, the internal memory residing at an address within the cache memory and having a dynamically variable size.

5. The method of claim 4 further including executing the unsecure code from at least one of the internal memory and the external memory.

6. The method of claim 4 further including executing the secure code from the internal memory in an event the secure code is authenticated.

7. The method of claim 6 further including continuing to authenticate procedures triggered by execution of the secure code in an event the secure code is authenticated.

8. The method of claim 3 further including storing the secure code using instructions from the internal memory of the equipment.

9. The method of claim 1 further including executing the secure code in an event the secure code is authenticated.

10. The method of claim 9 further including copying the secure code into a secure internal writable memory using instructions from a read-only memory (ROM), the secure internal memory being a partition of a cache memory, and executing the secure code from the secure internal writable memory.

11. The method of claim 10 further including loading secure keys associated with the equipment from the external memory using the secure code.

12. The method of claim 11 wherein the secure keys include at least one of a device authentication key, a redundant device authentication key, a chip encryption key, image authentication key, a memory protection key, and a secure storage key.

13. The method of claim 11 wherein the secure keys are encrypted.

14. The method of claim 11 further including authenticating the secure keys using the secure code.

15. The method of claim 11 further including determining if updates to the secure keys are available using the secure code.

16. The method of claim 15 further including updating the secure keys using an update code.

17. The method of claim 11, wherein a secure code authenticator is a function of the authentication key and the secure code, the authentication key being a function of a Master Authentication Key (MAK) associated with the equipment.

18. The method of claim 17 wherein the authentication key is encrypted.

19. The method of claim 17 further including executing the secure earliest boot code from the secure internal writable memory.

20. The method of claim 17 further authenticating the authentication key and in an event the authentication fails, executing the unsecure code with an appropriate error indication.

21. The method of claim 11 further including comparing the secure keys to a secret key using the secure code and in an event the comparison fails, issuing an error indication.

22. The method of claim 1 further including generating an error signal in an event authentication of the secure code fails.

23. The method of claim 1 wherein the unsecure code includes limited functionality.

24. The method of claim 23 wherein having limited functionality includes having limited access to structures of the equipment.

25. The method of claim 23 wherein having limited functionality includes having limited access to software stored on the equipment.

26. The method of claim 23 wherein the unsecure code is unencrypted and alterable.

27. The method of claim 23 further including providing the limited functionality for a predetermined period of time.

28. The method of claim 1 further including determining the authentication key as a function of a Master Authentication Key (MAK) associated with the equipment.

29. The method of claim 1 wherein the secure code includes an authenticator, the authenticator being a function of the authentication key.

30. The method of claim 1 wherein the authentication key is an Advanced Encryption Standard (AES) Key.

31. The method of claim 1 wherein the equipment is at least one of a network processor, a general purpose processor system-on-chip, and a mother board.

32. The method of claim 1 wherein the secure code is unencrypted.

33. The method of claim 1 further comprising updating secure keys associated with the equipment using an authentication key.

34. An apparatus for authenticating and associating a secure code with an equipment, the apparatus comprising:
a loader that loads the secure code from an external memory at startup time; and
an authenticator that authenticates the secure code using an authentication key associated with the equipment and in an event authentication of the secure code fails, executes an unsecure code.

35. The apparatus of claim 34 wherein the external memory is at least one of an unsecure memory, a reprogrammable flash memory, or a read-only memory (ROM).

36. The apparatus of claim 34 wherein the equipment further includes an internal memory configured to store the secure code.

37. The apparatus of claim 36 wherein a cache memory is partitioned to include the internal memory, the internal memory being arranged to reside at an address within the cache memory and including a dynamically variable size.

38. The apparatus of claim 37 wherein the unsecure code is executed from at least one of the internal memory and the external memory.

39. The apparatus of claim 37 wherein the secure code is executed from the internal memory in an event the secure code is authenticated.

40. The apparatus of claim 39 wherein procedures triggered by execution of the secure code are continued to be authenticated in an event the secure code is authenticated.

41. The apparatus of claim 36 wherein the secure code is stored using instructions from a read-only memory (ROM).

42. The apparatus of claim 34 wherein the secure code is executed in an event the secure code is authenticated.

43. The apparatus of claim 42 wherein the secure code is copied into a secure internal writable memory using instructions from a read-only memory (ROM), the secure internal writable memory being a partition of a cache memory, and wherein the secure code is executed from the secure internal writable memory.

44. The apparatus of claim 43 wherein secure keys associated with the equipment is loaded from the external memory using the secure code.

45. The apparatus of claim 44 wherein the secure keys include at least one of a device authentication key, a redundant device authentication key, a chip encryption key, an image authentication key, a memory protection key, and a secure storage key.

46. The apparatus of claim 44 wherein the secure keys are encrypted.

47. The apparatus of claim 44 wherein the secure keys are authenticated using the secure code.

48. The apparatus of claim 44 further including an updater that determines if updates to the secure keys are available using the secure code.

49. The apparatus of claim 48 wherein the updater updates the secure keys using an update code.

50. The apparatus of claim 48 wherein a secure code authenticator is a function of the authentication key and the secure code, the authentication key being a function of a Master Authentication Key (MAK) associated with the equipment.

51. The apparatus of claim 50 wherein the authentication key is encrypted.

52. The apparatus of claim 50 wherein the secure earliest boot code is executed from the secure internal writable memory.

53. The apparatus of claim 50 wherein the authenticator authenticates the authentication key and in an event the authentication fails, executes the unsecure code with an appropriate error indication.

54. The apparatus of claim 44 further including a comparer that compares the secure keys to a secret key using the secure code and in an event the comparison fails, issues an error indication.

55. The apparatus of claim 34 wherein an error signal is generated in an event authentication of the secure code fails.

56. The apparatus of claim 34 wherein the unsecure code includes limited functionality.

57. The apparatus of claim 56 wherein the unsecure code has limited access to structures of the equipment.

58. The apparatus of claim 56 wherein the unsecure code has limited access to software stored on the equipment.

59. The apparatus of claim 56 wherein the unsecure code is unencrypted and alterable.

60. The apparatus of claim 56 wherein the limited functionality is provided for a predetermined period of time.

61. The apparatus of claim 34 wherein the authentication key is determined as a function of a Master Authentication Key (MAK) associated with the equipment.

62. The apparatus of claim 34 wherein the secure code includes an authenticator, the authenticator being a function of the authentication key.

63. The apparatus of claim 34 wherein the authentication key is an Advanced Encryption Standard (AES) Key.

64. The apparatus of claim 34 wherein the equipment is at least one of a network processor, a general purpose processor system-on-chip, and a mother board.

65. The apparatus of claim 34 wherein the secure code is unencrypted.

66. The apparatus of claim 34 wherein secure keys associated with the equipment is updated using an authentication key.
